(19) United States
(12) Patent Application Publication
(10) Pub. No.: US 2006/0073318 A1
(43) Pub. Date: Apr. 6, 2006

(54) Opaque decorative film and construction laminates employing same

(75) Inventors: Benjamin Tuttle, Schwenksville, PA (US); Ronald Rodeck, Hockessin, DE (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Applied Extrusion Technologies, Inc., New Castle, DE (US)

(21) Appl. No.: 11/188,523

(22) Filed: Jul. 25, 2005

Related U.S. Application Data
(63) Continuation-in-part of application No. 10/959,525, filed on Oct. 6, 2004.

(51) Int. Cl. B32B 27/32; B32B 7/12; B32B 21/04

(52) U.S. Cl. 428/220; 428/523; 428/343; 428/337; 428/703; 428/537.1

(57) ABSTRACT

A monolayer or multilayer film having a desired decorative appearance for use as an overlay to cover substrates employed in the construction field to provide construction laminates having a desired decorative appearance. The film overlays include, on one surface thereof, a functional adhesive primer for receiving an aqueous adhesive thereon for bonding the film to the substrates. The film includes an opposed surface having a desired decorative appearance. In one preferred embodiment, the monolayer film or core layer of the multilayer film includes a polyolefin blended with one or more opacifying agents, preferably including a non-voiding opacifying agent without the use of a void-creating additive therein. In certain multilayer film embodiments the core layer can include a void creating additive, either without a non-voiding opacifying. Laminates including the film overlays of this invention bonded to substrates to form construction panels also form a part of the invention.

### RELATED APPLICATIONS

This application is a continuation-in-part of application Ser. No.10/959,525, filed on Oct. 6, 2004, and titled “Opaque Decorative Film and Construction Laminates Employing Same.”

### BACKGROUND OF THE INVENTION

The prior art literature discloses the use of opaque polypropylene films including organophilic kaolin in it, for use in laminating to paper and paperboard substrates of lower brightness than the film, for the purpose of providing a decorative coating. The disclosed polypropylene films are biaxially oriented and include 20%, by weight, of the organophilic kaolin.

The literature further discloses the coating of the kaolin-filled, polypropylene films with a clay-starch coating that is strong enough to enable the use of heat-set letterpress inks in printing. The literature also states that the coating of the plastic film improved the sheet stiffness and “rattle” and appears to offer an approach for producing plastic films with paper-like properties.

Publication No. US 2003/0077470 discloses laminated packaging materials employing a paperboard substrate and, in one embodiment, a pigmented opaque polymer film applied directly to the substrate. In the disclosed constructions the polymer film is applied directly to the substrate without any separate adhesive, but rather by either extrusion or hot melt adhesion. No separate adhesive component is employed. The paperboard substrate to which the polymer film is adhered is disclosed as being in the thickness range of 7 mils to 32 mils. Moreover, an important aspect of the prior art product is that the polymer film is not intended to be decorated (i.e., preprinted) prior to lamination to the paperboard substrate.

U.S. Pat. No. 4,898,752, issued to Cavagna et al., discloses a packaging material similar to that disclosed in the above-discussed '470 publication. In the Cavagna et al. product, a flexible paperboard substrate initially is provided with a coating of a synthetic latex, e.g., polyvinylacetate, styrene butadiene and acrylics, either alone or in combination, and then subsequently that coating is printed. The printing operation takes place either on the same press in which the coating is applied or on an off-line press. In either event, the printing of desirable graphics does not take place until after the coated laminate is formed.

Although the prior art literature discloses polyolefin films with kaolin for use as a decorative covering for paper and paperboard substrate (e.g., packaging or wrapping materials), a need exists to provide such a decorative film laminates employed in the construction field, such as decorative laminates employed in the fabrication of ceilings, floors, moldings, walls and interior surfaces of vehicles (e.g., RV's, trailers, boats, etc.) and in the construction of furniture, e.g., cabinets, shelving, desks, etc. Such decorative films need to have the desired adhesive characteristics to firmly retain the film on a desired, substantially rigid substrate with conventional water-based adhesives, and most preferably, with the failure mode, upon peeling of the film from the substrate, being at the adhesive, substrate interface. Moreover, for furniture and similar products the decorative films of the laminates need to be sufficiently durable to withstand the mechanical abuse, or wear, to which such products are commonly exposed. For other applications, such as in wall and ceiling panel laminates, the degree of durability of the decorative film need not be as great as for furniture and related applications. It is to decorative films of variable durability and construction laminates employing such films as overlays that the present invention relates.

### SUMMARY OF THE INVENTION

A monolayer or multilayer polyolefin film includes opposed surfaces. One of said surfaces receives a water-based adhesive thereon for securing the film to a desired construction substrate, as an overlay. The opposed surface is visually exposed to provide the desired, decorative surface appearance to the laminate.

Unless specified otherwise, reference throughout this application to a surface of the film or laminate providing a desired “decorative surface appearance,” “a decorative appearance,” or descriptions of similar import, includes both surfaces that are not printed with a separate decorative pattern (i.e., the decorative appearance is provided by the as formed shade or color of the exposed surface of the film or laminate), and surfaces that are printed to provide a separate decorative pattern on the visually exposed surface of the film or laminate. However, an important aspect of this invention is that the decorative appearance, regardless how achieved, is provided on the film prior to the film being bonded to a desired construction substrate.

In accordance with an important aspect of this invention, the surface for receiving the water-based adhesive is first provided with a coating of a functional adhesive primer, preferably a polar adhesive primer that effectively adheres to the polyolefin film surface and provides a primer coating to tenaciously receive a conventional water-based adhesive thereon.

In accordance with this invention, a monolayer film or the core layer of a multilayer film includes an opacifying agent to mask or hide undesired surface characteristics of a substrate to which the film is to be attached. The opacifying agent can be a non-voiding agent in a monolayer film and, in the core layer of a multilayer film, can be a voiding agent, a non-voiding agent or a blend of voiding and non-voiding agents, depending on the properties that are desired/required in the film.

In the most preferred embodiments, where high durability is desired, the opacifying agent(s) preferably are non-voiding agents, such as, for example, titanium dioxide, carbon black, small particle size barium sulfate and zinc oxide, without the inclusion of any void-creating additives, such as calcium carbonate. When whiteness is an important attribute, which it is in the most preferred embodiments of this invention, the non-voiding agent most preferably is, or includes titanium dioxide, which preferably is present in an amount in excess of 10% and more preferably in an amount in excess of 15%. The upper limit is restricted or limited by processing considerations and, in some cases, strength considerations. In the more preferred embodiments of this invention the titanium dioxide is present in an amount no greater than 25%, and more preferably no greater than 20. When other non-voiding agents are employed, e.g., carbon black, small particle size barium sulfate, zinc oxide, etc., the required percentages of these latter agents to achieve the desired opacity may be different from the percentages of titanium dioxide that need to be employed.

The films of this invention preferably have an opacity in the range of at least 55% to in excess of 90%; more preferably 92% or greater, as measured by ASTM D 589-97 (2002). Opacity is a function of both the thickness of the film and the percentage of opacifying agent (e.g., titanium dioxide) included in the film. Specifically, increasing either the thickness of the film or the percentage of the opacifying agent increases the opacity of the film. For some applications, such as applications in which the film is to be printed, e.g., printed cabinet liners, printed shelving, printed furniture products, etc., the films of this invention can have a relatively low opacity on the order of at least 55% and more preferably in excess of 60%. However, the industry standard for opacity in films of this invention is approximately 92%.

In the most preferred embodiments of this invention the film has a thickness of at least 55 gauge (13.75 microns), more preferably 70-80 gauge (17.50-20 microns) and in the most preferred embodiments requiring a high opacity in excess of 90%, a thickness in the range of 170-250 gauge (42.5-62.5 microns) and most preferably in the range of 200-225 gauge (50-56.25 microns).

It should be understood that hiding power is an important attribute of the films of this invention. That is, the ability of the film to mask or hide any undesired surface appearance of the substrate to which the film is to be adhered. Hiding power can be enhanced through a combination of opacity and higher gloss in the films of this invention. In other words, if high gloss is an acceptable characteristic or property of the film, it may be possible to employ lower levels of an opacifying agent in the film and yet achieve the desired hiding power. However, the current market trend is away from high gloss, thereby requiring the desired hiding power to be established principally by the opacifying agent(s) that are employed in the film.

In high durability applications, it is very desirable that Z-direction failure of the film not occur. That is, when the film is separated from the substrate to which it is attached, the separation, or failure preferably takes place at the adhesive/substrate interface; not through the Z-direction of the film. When the film is attached to a fibrous substrate, e.g., a plywood board, this mode of failure results in fiber pick-off on the adhesive surface of the separated film. The primer employed in this invention, which will be discussed in greater detail later in this application, is a very important component in avoiding, or reducing, the likelihood of Z-direction failure through the film. In particular, the primer and adhesive need to be selected such that the peel strength between the adhesive and the upper surface of said substrate to which it is attached is less than the peel strength between the functional adhesive primer and film and between the functional adhesive primer and adhesive.

In accordance with another aspect of this invention, when high durability to mechanical abuse or wear is not a significant issue, multilayer films of this invention can include a conventional voiding agent, e.g., calcium carbonate, in a core layer thereof, to provide a reduced density film that is less durable to mechanical abuse than a decorative film free of void creating additives. Such reduced density films can be desirably employed for a number of applications, such as in the fabrication of decorative wall and ceiling panels, where durability and physical abuse or wear of the surface is not a major problem. When a voiding agent is employed in the core layer it can be employed as the sole opacifying agent, or if desired, with a non-voiding agent such as titanium dioxide. When titanium dioxide is utilized with a voiding agent it preferably is employed at a reduced level relative to the levels employed when used alone or with other non-voiding agents.

The films of this invention employing a voiding agent are multilayer films, with a voiding agent included in the core layer. Monolayer films including a voiding agent are not sufficiently durable or strong for use in the construction laminates of this invention.

Although when a voiding agent is employed in the core layer it also is believed to be important to include at least a small percentage of a whitening agent in the core layer to provide an acceptable surface appearance, it is within the broadest scope of this invention to eliminate the use of a whitening agent in a core layer that includes a voiding agent therein. However, it should be emphasized that in the applications contemplated in this invention, it is unlikely that a film including only a voiding agent in the core layer, without a whitening additive such as titanium dioxide, will provide the desired visual appearance to render a construction laminate employing the film acceptable for its intended use.

In a preferred embodiment, the functional adhesive primer is a water-based primer and most preferably is a polar, acrylic-based coating (e.g., Adcote 611JH64A manufactured by Rohm & Haas, which is located in Philadelphia, Pa., NeoCryl XK90 and NeoCryl 5045 manufactured by NeoResins, which has its World Headquarters in The Netherlands and its North American Headquarters in Wilmington, Mass.). However, within the broadest scope of the invention other water-based or solvent based materials can be employed as the functional adhesive primer, such as urethane-based coatings (e.g., NeoResins R600 manufactured by NeoResins), polyethylene Imines (PEI) (e.g., Mica A-131-X, produced by MICA Corporation of Shelton, Conn.), ethylene vinyl acetates (e.g., Adcote 37P295 and Adcote 37T77 manufactured by Rohm & Hass), polyesters (e.g., Eastek 1200 and 1300 manufactured by Lawter, a division of Eastman Chemical Company located in Pleasant Prairie, Wisc.), polyamides (e.g., Versamid 973 manufactured by Cognis Corporation in Ambler, Pa.), etc. The above-identified functional adhesive primers are exemplary only. A person skilled in the art and understanding the required attributes of the primer can easily determine acceptable adhesive primers for use within the broadest scope of this invention.

As noted, above, in the most preferred embodiments of this invention the functional adhesive primer is water-based. However, it should be noted that Versamid 973 (a polyamide) is not water based, but rather is a solid composition of acetate and toluene. This latter solvent is not well suited for in-line application, e.g., application between the machine direction and cross-machine direction orientation step in a conventional film forming line, in part because of the cost of equipment that would be required to be included in the line to effectively and properly handle such solvent based materials (e.g., oxidative systems for use in disposing of the evaporated solvent). In addition, PEI also is not well suited for in-line application because it has inadequate stretch properties for such use. Thus, for in-line application, which is the preferred method of forming the decorative films of this invention, the primer must have sufficient stretch properties to be able to withstand the transverse stretching operation after application to the film.

Thus, in the most preferred embodiments of this invention the functional adhesive primers are water-based coatings that are applied in-line to the polyolefin film by a conventional gravure printing operation after the film has been oriented in the machine direction, but prior to orientation of the film in the cross-machine direction. Although the preferred film is formed in-line in a conventional tenter machine with the coating applied between the machine direction and cross-machine direction orientation steps, it is within the broadest scope of this invention to apply the adhesive primer to the film in a separate, off-line operation. In an off-line system capable of handling solvent-based systems a solvent based primer may be usable.

One of the significant benefits of this invention is that conventional, well-known, water-based adhesives can effectively be utilized to adhere the film to a desired substrate of the type employed in the construction field. Representative water-based adhesives usable in this invention are synthetic polymer adhesives (e.g., Bondmaster Vy-Lok 40-1105 and BondMaster 40-0844 manufactured by National Adhesives, a division of National Starch located in Salisbury N.C., and #60 manufactured by Sun Adhesives Corporation in Decatur, Ala.) and ethylene vinyl acetate adhesive emulsions (e.g., #7200 manufactured by Sun Adhesives), although people skilled in the art clearly can select other water-based adhesives that would be usable in this invention.

Although the functional water-based adhesive primer and water-based adhesive can be applied to a monolayer polyolefin film, such as a monolayer film including one or more polyolefins, in the most preferred embodiment of this invention the film for receiving the functional water-based coating and water-based adhesive is a multilayer structure including a central core and opposed outer skin layers.

In accordance with an additional aspect of this invention, a decorative film of this invention can be adhesively bonded to one or both surfaces of a construction substrate and most preferably has good moisture barrier properties. Alternatively, the decorative film can be adhesively bonded to one of the surfaces of the substrate and, to prevent warping, which may occur if the laminate is exposed to high relative humidity conditions, the opposite side of the substrate can be provided with another film that functions as a moisture barrier. Low cost biaxially oriented polypropylene films having moisture barrier properties are well known in the art, and can easily be selected by a person skilled in the art without any undue experimentation. Such a film can be a thin, clear, multilayer film, possibly provided with an EVA (ethylene vinyl acetate) adhesive to adhere it to the opposite side of the construction substrate. A typical high moisture barrier film that may be utilized in this invention is a 48 gauge, monolayer polypropylene homopolymer film including a slip additive and sold by Applied Extrusion Technologies under the brand designation B523. When the decorative film and opposed film both have desired moisture barrier properties, moisture is only capable of penetrating the substrate through the edges of the board. Such penetration should not cause distortion or twisting of the laminate; thereby resulting in a very stable construction laminate.

### DESCRIPTION OF PREFERRED EMBODIMENTS

As noted earlier, this invention relates broadly to both monolayer and multilayer polyolefin films and to laminates employed in the construction field and including those films as overlays. In the most preferred embodiments the film is a multilayer film including a central core and opposed outer skin layers. In fact, only multilayer films are usable when a voiding agent is employed to provide enhanced opacity to the film, as was described above.

The monolayer films of this invention and the internal core layer of the multilayer films of this invention are principally a polyolefin and most preferably a polypropylene.

“Polypropylene” as utilized in this application includes, for example, polypropylene homopolymers and propylene copolymers, including but not limited to block copolymers. The term “propylene copolymers” includes polymers of propylene with at least one other α-olefin, preferably C₂C₃ copolymers with less than 10% by weight C₂ or C₃C₄ copolymers with less than 30% C₄.

For construction laminates, oriented polypropylene films of this invention have a number of very desirable properties versus vinyl. First, when employed on substrates that tend to release formaldehyde e.g., medium density fiberboard and particle board, the polypropylene films function as a very effective barrier to the formaldehyde, without itself releasing other harmful components into the atmosphere. Although vinyl also provides a reasonably effective barrier to formaldehyde, it generally includes plasticizers that may emit noxious and harmful vapors into the atmosphere. In addition, polypropylene films of this invention did not shrink or creep during heat aging tests, which provides for greater dimensional stability than other decorating materials, such as vinyl.

In one preferred embodiment, which is very durable to mechanical abuse, the monolayer film or the core layer in the multilayer film includes primarily homopolymer polypropylene, over 10% and more preferably over 15% of a whitening agent, such as titanium dioxide, a minor percentage of a UV stabilizer, and is free of a void-creating additive. It is within the scope of the invention to employ mini random C₂C₃ copolymers including less than 1% C₂ in place of, or in addition to the homopolymer polypropylene. Moreover, as will be discussed in greater detail hereinafter, in certain preferred embodiments, where durability to mechanical abuse is not a significant issue, a voiding agent can be included in the core layer of a multilayer film of the invention to provide a reduced density, lower cost structure (e.g., lower cost per unit area) with the desired opacity. In these latter embodiments, which only include multilayer films of the invention, the amount of whitening agent that is employed can be reduced when employed with a voiding agent. In accordance with the broadest aspect of this invention it may be possible to eliminate the use of a whitening agent when a voiding agent is employed in the core layer.

As also noted earlier, it is within the broad scope of this invention to include non-voiding agents in addition to, or in place of titanium dioxide, where whiteness is not an important attribute. Such non-voiding agents include but are not limited to carbon black, small particle size barium sulfate and zinc oxide. Also, these additional non-voiding agents may be employed in combination with a void-creating additive, where strength and durability requirements permit. However, as noted above, clearly the most preferred embodiments of this invention employ titanium dioxide as an opacifying agent to also provide a degree of whiteness that is required in the great majority of end use, construction applications.

In one preferred construction, the monolayer film of the invention and the core layer of the multilayer film of the invention included 52% Total 3371 (homopolymer polypropylene), 45% WP240 (40% titanium dioxide in a carrier of 60% Sunoco XJ-015, a mini random ethylene/propylene random copolymer including approximately 0.6% ethylene manufactured by the Polymer Division of Sunoco, Inc., located in Pittsburgh, Pa.) and 3% Ampacet 402705 (15% Tinuvin 783 (UV stabilizer) and 5% Armostat 300 (antistat) in a carrier of 80% homopolymer polypropylene). In place of the Sunoco XJ-015, applicants are now employing British Petroleum BP 10-6384, which is substantially the same polymer composition as the XJ-015.

Total 3371 is manufactured by Total Petrochemicals, Inc. located in Houston, Tex. WP 240 is manufactured by Washington Penn Plastics Co., Inc. in Washington, Pa., and Ampacet 402705 is manufactured by Ampacet Corporation in Tarrytown, N.Y.

In a preferred structure, the skin layer for receiving a functional, water-based adhesive primer thereon is a polypropylene, and for example is 97.4% BP 10-6384 mini random copolymer of ethylene and propylene manufactured by British Petroleum, and 2.6% Ampacet 402705 (15% by weight Tinuvin 783 (UV stabilizer) and 5% Armostat 300 (antistat) in 80% by weight homopolymer polypropylene). The main function of the skin layer is to present a smooth surface to the gravure printing roll employed to dispense or meter a coating of the functional, water-based adhesive primer onto the outer exposed surface thereof in the most preferred, in-line forming operation. If this skin layer were not employed, the gravure printing roll would directly contact the more abrasive outer surface of the core layer, and would tend to experience undesired wear. It should be understood that the core layer is more abrasive as a result of the inclusion of an opacifying agent therein, and most preferably a high concentration of a non-voiding opacifying agent (e.g., titanium dioxide) included in some embodiments of the invention; the inclusion of a high concentration of a void-creating additive in other embodiments of the invention or a high concentration of a blend of void-creating additives and non-void creating additives in still other embodiments of this invention.

The opposed skin layer is the visually exposed surface of the laminate required to provide the desired decorative appearance in the construction laminates of this invention, as will be described in greater detail hereinafter. In certain preferred embodiments this opposed skin layer is provided with a desired decorative appearance by the inclusion of a printed pattern thereon. However, in accordance with the broadest aspect of this invention, the films of this invention can be sold as-is, without a separate, decorative printed pattern on the opposed skin layer thereof.

If desired, or required, the opposed skin layer (i.e., the skin layer opposed to the one that receives the primer and adhesive thereon) can be provided with a conventional protective coating to provide scuff and scratch resistance to the surface, and also, if desired, can be provided with a metallized surface; e.g., aluminum, as is well known in the art. It should be understood that the particular protective coating or metal coating or layer that is employed is not a limitation on the broadest aspects of this invention, since suitable protective coatings, as well as metals employed to form a very thin metallized layer are well known to those skilled in the art. This opposed skin surface is selected to provide the desired gloss in the completed decorative product, and for many applications the desired appearance requires a low gloss surface. As explained earlier, where low gloss is not a requirement in the completed, decorative product, the film may be provided with the desired hiding power by reducing the amount of opacifying agent while increasing the gloss. However, it should be emphasized that in the most preferred embodiments of this invention the opacifying agent includes titanium dioxide in a percentage in excess of 10%, by weight, based upon the weight of the layer in which it is included because whiteness is an important attribute in the majority of construction applications in which the laminates of this invention are intended to be employed.

In a preferred embodiment of this invention, the skin layer providing the visually exposed surface of the film is a low gloss surface formed of polypropylene, and more preferably of a blend including over 50%, and more preferably 65%, of an ethylene/propylene copolymer including less than 10% ethylene in it. Most preferably the copolymer that is employed is sold by Total under the designation Total 8573; including approximately 4.5% ethylene in it. The ethylene propylene copolymer is blended with approximately 32% of a calcium carbonate concentrate sold by Ampacet Corporation located in Tarrytown, N.Y., under the designation Ampacet 411342, and 3% of a UV stabilizer concentrate sold under the designation Ampacet 402705.

The Ampacet 411342 concentrate employed in the decorative, or printable, layer is in the form of blended pellets including 62.5% by weight calcium carbonate (approx. 3 microns), 7.5% by weight titanium dioxide, and 29.37% by weight of Sunoco XJ-015 mini-random copolymer of ethylene and propylene and 0.63 by weight antioxidants. Thus, the actual percentage by weight of calcium carbonate in the decorative layer is 20% by weight (32%×62.5%) and the percentage of titanium dioxide in the printable layer is 2.4% by weight (32%×7.50%). A concentrate that is essentially equivalent to the Ampacet 411342 concentrate is formulated by Washington Penn Plastic Company, Inc. under the brand designation WP56288. This latter formulation is essentially the same as the Ampacet 411342 but employs BP 10-6384 as the mini random copolymer of ethylene and propylene in place of the Sunoco XJ-015 mini-random copolymer.

The Ampacet 402705 in the decorative layer also is in the form of blended pellets including 15% Tinuvin 783 (UV stabilizer) by weight and 5% Armostat 300 (antistat) in 80% by weight homopolymer polypropylene carrier.

The preferred formulation for the outer visually exposed skin layer, which can, if desired, be a printable layer, is selected to provide a desired low gloss surface, which is referred to as a satin appearance. It should be understood that the formulation of the skin layer can be modified depending on the desired gloss of the surface. The inclusion of a separate, outer skin layer on the surface of the core opposed to the adhesive receiving surface provides a basis for controlling the gloss of the visually perceptible surface in the completed, laminated constructions of this invention.

All references to percentages of the various components in the films of this invention are percentages by weight.

Preferably the core layer of the multilayer films of this invention is the thickest component, with the skin layers and water-based primer coating including only a small percentage of the thickness of the film. However, it is within the scope of this invention to vary the thickness of the various components and in some cases the core layer may not be the thickest component. In a representative, non-limiting embodiment of this invention wherein the core layer is not voided, the core layer is approximately 196 gauge (1.96 mil) thick, the printable, or otherwise viewable skin layer is approximately 12 gauge (0.12 mil) thick, the skin layer for receiving the water-based primer is approximately 10 gauge (0.1 mil) thick and the water-based coating on this latter skin layer is approximately 2 gauge (0.02 mil) thick. In embodiments employing a voided core the thickness of the core will be somewhat higher, e.g., on the order of 300 gauge (3 mil).

Most preferably the decorative skin layer, when intended to receive a printing ink thereon, is oxidatively treated; preferably corona treated, to enhance ink receptivity, as is well known in the art.

The polyolefin film, with the functional adhesive primer thereon can be employed as a decorative covering, or overlay, for a number of substrates employed in the construction field, and most desirably substrates employing a wood grain that is intended to be covered or masked by the overlay. For example, the decorative films of this invention can be bonded through conventional water-based adhesives to gypsum, lauan plywood, medium density fiberboard, hardboard, particle board and other similar substrates employed in the construction field. Although the thickness of the construction substrates usable in this invention can vary within wide limits, and is not a limitation on the broadest aspects of this invention, in the preferred embodiments of this invention the thickness of the construction laminates employed in this invention is greater than 100 mils; more preferably in excess of 150 mils and even more preferably in excess of 180 mils. These preferred construction laminates are substantially different from the substrates employed in the packaging field, such as the substrates disclosed in the aforementioned '470 patent publication, which has a disclosed thickness in the range of 7 mils to 32 mils.

It is very desirable in this invention to provide a functional adhesive primer that maintains a strong inter-surface bond to the outer layer of the polyolefin film on one side of said primer, and to the adhesive layer on the opposed side of said primer. Specifically, the glue desirably should be tenaciously retained on the decorative film structure, or overlay, such that, upon peeling the decorative film overlay off of a substrate that is usable in the construction field, to which it is attached, the separation takes place at the glue-substrate interface, with fibers of the substrate (when the construction substrate includes wood fibers) actually being adhered to the adhesive layer at the surface of separation. In other words, the decorative film, upon being peeled from a wood or fibrous construction substrate to which it is laminated, in most instances will have fibers of the substrate retained therein.

Reference throughout this application to “upper” and “lower” surfaces of the substrate is intended to define the relative positions of the major surfaces of the substrate and not the absolute position of those surfaces in use of the construction laminates of this invention. Specifically, reference to “upper” and “lower” in referring to surfaces of the substrate is intended to identify the opposed major surfaces of the substrate and distinguish those surfaces from the peripheral edge surfaces of the substrate.

As pointed out herein, the laminates of the present invention are construction laminates, as opposed to laminates in which the substrate is a more flexible paper or paperboard substrate of the type employed in product packaging applications. For example, preferred laminate constructions of this invention are employed as wall panels, ceiling panels, moldings, floor panels, panels for interior surfaces of vehicles (e.g., RV's trailers, boats, etc.), panels for cabinet liners and panels for other furniture.

In some applications, the use of calcium carbonate or other void creating additives to form substantial voids in the monolayer structures of this invention or in the core layer of the multilayer structures of this invention is avoided to provide a structure that is more durable to mechanical abuse or wear than one including a voiding agent, and also to prevent an undesirable reduction in the Z direction strength of the film close to the bonded interface between the film and the construction substrate to which it is laminated. The creation of such an undesirable reduction in the Z direction strength might cause the film to tear through the core and/or skin layer on which the primer and adhesive is retained, upon separation of the film from the substrate to which it is attached. In addition, as noted above, for certain applications where stringent durability requirements exist, such as in floor, furniture and shelving constructions, voided structures are generally avoided. The preferred standard in the industry is that upon peeling the decorative film overlay from a wood substrate, separation should take place at the bonded interface of the film to that substrate, and that the film should not experience Z direction tearing through other components of the film, such as through the core layer and the skin layer including the primer and adhesive that are weakened by the inclusion of calcium carbonate or a similar void-creating additive.

However, in certain preferred embodiments of this invention wherein durability to mechanical abuse or wear are not issues of concern, lower density, multilayer films are desired; principally to reduce cost per unit weight. In these latter embodiments, void-creating additives, e.g., synthetic, natural or organic, can be employed in the core layer of the multilayer films. Desirably, when some Z-direction strength is desired, the void-creating additive should be present in amounts, by weight, of less than 10%; more preferably 4% or less, and most preferably in the range of 1%-4%. For applications wherein Z direction strength is of less importance, the percentage of the void-creating additive can be at or above 10%, e.g., in the range between about 10 and 25%. Most preferably the void-creating additive is calcium carbonate in the particle size range of 1-5 microns. However, the type of void-creating additives employed in this invention is not a limitation on the broadest aspects of this invention, and can include other additives, such as silicon dioxide, aluminum silicate, magnesium silicate, organic voiding agents and synthetic voiding agents, to name a few. These void-creating additives most commonly are in the size range of 1-5 microns, and generally do not exceed 10 microns. When a void creating additive is employed, the amount of whitening agent, e.g., titanium dioxide, that is employed generally can be substantially reduced since the required opacity is provided in large part by the void creating additive.

As noted earlier herein, monolayer films are not considered suitable for use as an overlay in a construction laminate when a voiding agent is intended to be included in the film forming the overlay. Also, although the level of whitening agent most preferably is reduced when a voiding agent is employed in the core layer of a multilayer film of this invention, it is possible to use the same high levels of whitening agent employed in films that do not include a voiding agent therein. However, using the same high levels of whitening agent in conjunction with a void-creating additive may unduly weaken the film, causing undesired Z-direction failure, even for applications in which high durability is not required.

It should be understood that other conventional additives may be added to one or more of the layers in the films of this invention. Such conventional additives include, but are not limited to pigments, orientation stress modifiers, antiblocking agents and slip agents.

Without further elaboration, the foregoing will so fully illustrate my invention that others may, by applying current or future knowledge; readily adopt the same for use under various conditions of service.

What we claim as the invention is the following:

1. A decorative film for use as an overlay for a substrate employed in laminates utilized in the construction field, said decorative film being a monolayer film or a multilayer film including a core layer, said film including on one surface thereof, a functional adhesive primer intended to receive an aqueous adhesive thereon, said film including an opposed surface having a desired decorative appearance, said monolayer film or the core layer of said multilayer film including a polyolefin blended with an opacifying agent.

2. The decorative film of claim 1, wherein said opacifying agent includes one or more non-voiding agents having a total percentage in excess of 10%, by weight, based upon the weight of the polyolefin in said monolayer film or of the polyolefin in the core layer of said multilayer film.

3. The decorative film of claim 1, wherein said opacifying agent includes at least 10% of a whitening agent, by weight, based upon the weight of the polyolefin in said monolayer film or of the polyolefin in the core layer of said multilayer film.

4. The decorative film of claim 3, wherein said whitening agent is present in an amount in excess of 15%, by weight, based upon the weight of the polyolefin in said monolayer film or of the polyolefin in the core layer of said multilayer film.

5. The decorative film of claim 3, wherein said whitening agent is present in an amount no greater than 25%, by weight, based upon the weight of the polyolefin in said monolayer film or of the polyolefin in the core layer of said multilayer film.

6. The decorative film of claim 4, wherein said whitening agent is present in an amount no greater than 25%, by weight, based upon the weight of the polyolefin in said monolayer film or of the polyolefin in the core layer of said multilayer film.

7. The decorative film of claim 1, wherein said polyolefin is polypropylene.

8. The decorative film of claim 1, being a multilayer structure having a core layer and opposed outer skin layers, said blend of polyolefin and opacifying agent being in said core layer.

9. The decorative film of claim 1, wherein said opacifying agent is titanium dioxide.

10. The decorative film of claim 9, wherein said titanium dioxide is present in an amount of approximately 18%.

11. The decorative film of claim 1, wherein said functional adhesive primer is selected from the group consisting of acrylic coatings, ethylene vinyl acetate coatings, polyethylene imine coatings, polyester coatings, polyamide coatings and urethane coatings.

12. The decorative film of claim 8, including a void-creating additive in the core layer.

13. The decorative film of claim 12, said void creating additive being present in an amount of less than about 10% by weight of said core layer.

14. The decorative film of claim 12, wherein said void creating additive is calcium carbonate.

15. The decorative film of claim 12, wherein said void creating additive is present in an amount of no more than 4% by weight of said core layer.

16. The decorative film of claim 8, wherein said core layer is substantially free of a void-creating additive.

17. The decorative film of claim 1, said film having a thickness in the range of 170-250 gauge (42.5-62.5 microns).

18. The decorative film of claim 17, wherein said film has a thickness in the range of 200-225 gauge (50-56.25 microns).

19. A decorative, laminate structure including the decorative film of claim 1 adhered as an overlay to an upper surface of a substrate employed in the construction field through a water-based adhesive disposed between the functional adhesive primer and said upper surface of said substrate to form a laminated construction panel, said substrate having a lower surface opposed to said upper surface and peripheral edge surfaces.

20. The laminate structure of claim 19, wherein said substrate has a thickness in excess of 100 mils.

21. The laminate structure of claim 19, wherein said substrate has a thickness in excess of 150 mils.

22. The laminate structure of claim 19, wherein said substrate has a thickness in excess of 180 mils.

23. The laminate structure of claim 19, wherein the peel strength between the water-based adhesive and said upper surface of said substrate is less than the peel strength between the functional adhesive primer and film and between the functional adhesive primer and adhesive.

24. The laminate of claim 19, said decorative film being polypropylene.

25. The laminate of claim 19, said decorative film having moisture barrier properties and being adhered to said upper and lower surfaces of said substrate.

26. The laminate of claim 19, said decorative film having moisture barrier properties and being adhered to said upper surface of said substrate and a second polyolefin film having moisture barrier properties and being different from said decorative film and being adhered to said lower surface of said substrate.

27. The laminate structure of claim 19, wherein said substrate is selected from the group consisting of gypsum, lauan plywood, medium density fiberboard, hardboard and particle board, said decorative film being an overlay covering said substrate to form said laminated construction panel.

28. The laminate structure of claim 19, being in the group of construction laminates consisting of wall panels, floor panels, ceiling panels, panels for cabinet liners, panels for interior surfaces of vehicles and panels for other furniture and moldings.

29. The laminate of claim 19, said opacifying agent is said film including a non-voiding agent.

30. The laminate of claim 29, wherein said opacifying agent is a whitening agent.

31. The laminate of claim 30, wherein said whitening agent is titanium dioxide

32. The laminate of claim 30, wherein said titanium dioxide is present in an amount in excess of 10%, by weight, based upon the weight of the layer in which it is included.

33. A film overlay for use in covering a substrate employed in laminates utilized in the construction field, said film overlay being a multilayer film including a core layer and opposed outer skin layers, said film overlay including on one surface thereof, a functional adhesive primer intended to receive an aqueous adhesive thereon, said film including an opposed surface providing a desired decorative appearance, said core layer of said multilayer film including a void creating additive therein.

34. The film overlay of claim 33, wherein said core layer also includes a whitening agent therein.

35. The film overlay of claim 33, wherein said opposed surface is a printable surface.

36. The film overlay of claim 33, wherein said opposed surface is provided with a coating from the group consisting of scratch resistant coatings, a scuff resistant coating and metal coatings.

37. The film overlay of claim 33, wherein said polyolefin is polypropylene.

38. The film overlay of claim 34, wherein said void creating additive is calcium carbonate and said whitening agent is titanium dioxide.

39. The film overlay of claim 33, wherein said functional adhesive primer is selected from the group consisting of acrylic coatings, ethylene vinyl acetate coatings, polyethylene imine coatings, polyester coatings, polyamide coatings and urethane coatings

40. A construction laminate structure including the film overlay of claim 33 adhered to a substrate employed in the construction field through a water-based adhesive disposed between the functional adhesive primer and the substrate to form a laminated construction panel.

41. The laminate structure of claim 39, wherein said substrate is selected from the group consisting of gypsum, lauan plywood, medium density fiberboard, hardboard and particle board, said decorative film overlay covering said substrate to form said laminated construction panel.

42. The film overlay of claim 34, wherein said opposed surface is a printable surface.

43. The film overlay of claim 34, wherein said opposed surface is provided with a coating from the group consisting of scratch resistant coatings, scuff resistant coatings and metal coatings.

44. The film overlay of claim 34, wherein said polyolefin is polypropylene.
